(19) United States
(12) Patent Application Publication
(10) Pub. No.: US 2008/0283104 A1
(43) Pub. Date: Nov. 20, 2008

(54) REINFORCED AXILLARY CRUTCH WITH ADJUSTABLE HANDGRIP

(76) Inventor: KUAN-JEN WENG, Xinying City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/750,421

(22) Filed: May 18, 2007

(51) Int. Cl. A61H 3/02

(52) U.S. Cl. 135/72

(57) ABSTRACT

An axillary crutch is disclosed in the invention; the axillary crutch has a body comprised of two opposite shafts, each shaft has a wall portion embedded therein, so that the wall portions may serve as the basis for adjusting and positioning a handgrip. Therefore, the shafts do not need to be formed with holes for securing the handgrip, which not only maintains the strength of the shafts, but also reinforces the strength and security of the axillary crutch as a whole because the shafts are embedded with fortified wall portions therein. Moreover, the position of the handgrip may be adjusted according to the length of a user's arm, and a pivot fitted into the handgrip may hold the opposite shafts together, which prevents the two shafts from becoming deformed or twisted, or buckling due to external forces.

### FIELD OF THE INVENTION

The invention relates to an axillary crutch, and more particularly to a reinforced axillary crutch with adjustable handgrip.

### DESCRIPTION OF PRIOR ART

In conventional axillary crutches as disclosed in U.S. Pat. No. 4,865,065, U.S. Pat. No. 4,852,597, RE32,815, U.S. Pat. No. 4,733,682, and U.S. Pat. No. 4,509,741; most are comprised of two parallel shafts with a wider upper distance therebetween and a narrower lower distance therebetween; a shoulder support for supporting users under the armpit is disposed on top of the pair of shafts; a handgrip is disposed between the shafts that may have its position adjusted, while a lower tube for positioning and supporting users is disposed at the lower end of the shafts. However, to allow the position of the handgrip to be adjusted according to the length of a user's arm, a plurality of openings are formed on the shafts for screw joints and butterfly nuts to fit into, but this also compromises the structural strength of the shafts at such locations, even though the handgrip is where the greatest force is exerted upon the whole axillary crutch. As a result, the conventional axillary crutches are prone to bending or even breaking because the opening of holes thereon renders the crutches unable to withhold a strong exerted force. The common solution is to make the walls of the shafts thicker, though this also increases the cost for making such crutches.

Moreover, in other conventional axillary crutches as disclosed in U.S. Pat. No. 6,314,977, U.S. Pat. No. 5,381,813, U.S. Pat. No. 5,299,589, and U.S. Pat. No. 5,291,910; the handgrip is altered structurally so that the two shafts do not need to be formed with thru openings that completely penetrate the shafts, but the inner wall of the shafts must still be formed with thru openings to secure the handgrip. Although the damage from the formation of thru openings to the structural strength of the shafts is reduced as a consequence, the structure of the handgrip also becomes more complicated and vulnerable, which means the shafts and the handgrip are more difficult to make and assemble, and the shafts and the handgrip are also more difficult to disassemble and maintain in case of breakage.

Further, the assembly of all of the components of the aforesaid axillary crutch requires the use of rivets, which are not only more laborious but also require more components (such as rivets, nails, or screws) for the assembly thereof, and this in turn compromises the structural strength of the axillary crutch.

Therefore, the disclosure U.S. Pat. No. 5,605,170 sought to increase the structural strength of the axillary crutch and allow the components thereof to be assembled without the use of any tools. However, even though the position of the handgrip may be adjusted by inserting or removing a pivot protruding from the plugs at both ends of the handgrip into the positioning holes on the shafts, the pivot cannot restrain the two shafts when a force is exerted upon both shafts, and thus the shafts may easily buckle or twist outwards, which subsequently causes the pivot of the plugs become loosened from the positioning hole and possible injure the users.

### SUMMARY OF THE INVENTION

In order to reinforce the strength of the shafts in the axillary crutch and enhance the assembly between the handgrip and the shafts, a reinforced axillary crutch with adjustable handgrip is disclosed in the invention. The axillary crutch includes two opposite shafts that make up a body, and the shafts are formed with a connecting portion in the center and a slit in a lateral side, respectively, and a wall portion provided with a plurality of positioning holes is embedded between the sliding grooves provided at two inner lateral walls of each shaft; each positioning hole has a wider upper opening and a narrower lower opening.

Moreover, the handgrip of the invention comprises a pivot having two respective ends disposed with grooves for fastening with or separating from the narrower lower opening of each positioning hole, and the two ends correspond to the sliding grooves of each of the shafts, respectively; an extended portion having a protrusion that may fit into the wider upper opening of the corresponding positioning hole is upwardly extended from the two ends of the handgrip.

Therefore, a fortified wall portion is fitted into the shafts that make up the body of the axillary crutch before being bent into a predetermined shape together and secured in the shafts. The shafts are not formed with any thru openings, and thus are not compromised in terms of structural strength. In other words, the structure of the shafts remains complete, which significantly increases the ability of the shafts for holding heavier loads.

Furthermore, the two ends of the pivot fitted through the handgrip not only hold the two shafts together, but also prevent the two shafts from buckling outwards; while the protrusions on the extended portions at both ends of the handgrip may be fitted into the positioning hole to ensure the handgrip is securely positioned and protected from loosening.

### BRIEF DESCRIPTION OF DRAWINGS

The structure and the technical means adopted by the present invention to achieve the above and other objectives can be best understood by referring to the following detailed description of the preferred embodiments and the accompanying diagrams, wherein:

FIG. 1 is a three-dimensional schematic view that shows the structure of the invention.

FIG. 2 is a schematic view that shows the shaft and the wall portion disassembled from each other according to the invention.

FIG. 3 is a schematic view that shows the shaft and the wall portion assembled with each other according to the invention.

FIG. 4 is an exploded view that shows the middle tube and the lower tube according to the invention.

FIG. 5 is a schematic view that shows the middle tube and the two shafts assembled together according to the invention.

FIG. 6 is a cross-sectional view that shows the lower tube according to the invention.

FIG. 7 is a dissected longitudinal view that shows the lower tube according to the invention.

FIG. 8 is an exploded view that shows the handgrip according to the invention.

FIG. 9 is a cross-sectional view that shows the handgrip according to the invention.

FIG. 10 is a dissected longitudinal view that shows the handgrip according to the invention.

FIG. 11 is a schematic view that shows the first operation mode of the handgrip according to the invention.

FIG. 12 is a schematic view that shows the second operation mode of the handgrip according to the invention.

FIG. 13 is a schematic view that shows the application of the handgrip on an embodiment of the shafts according to the invention.

### DETAILED DESCRIPTION OF PREFERRED EMBODIMENTS

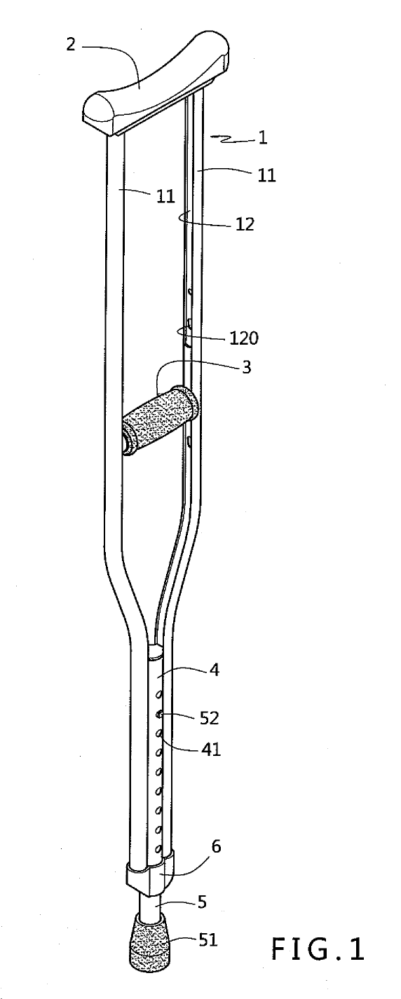

Referring to FIG. 1; the axillary crutch according to the invention includes a body 1 with a shoulder support 2 disposed on top of the body 1 for supporting users under the armpit; a lower tube 5 is disposed at a lower end of the body 1 that may be slid to adjust for positioning and leaning against the ground; a handgrip 3 is disposed in the middle of the body 1 for users to hold onto, wherein:

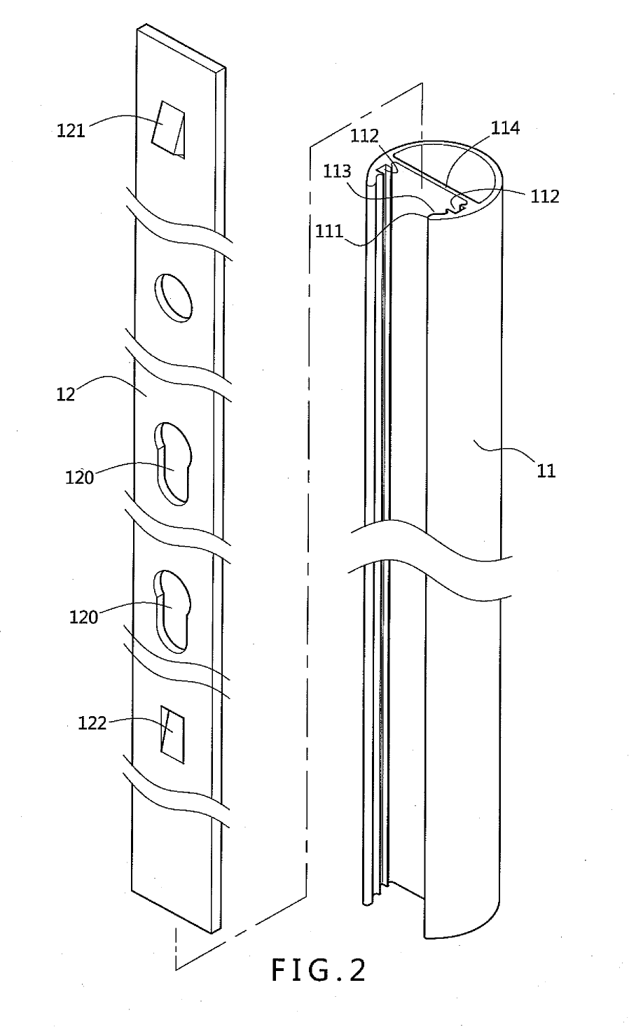

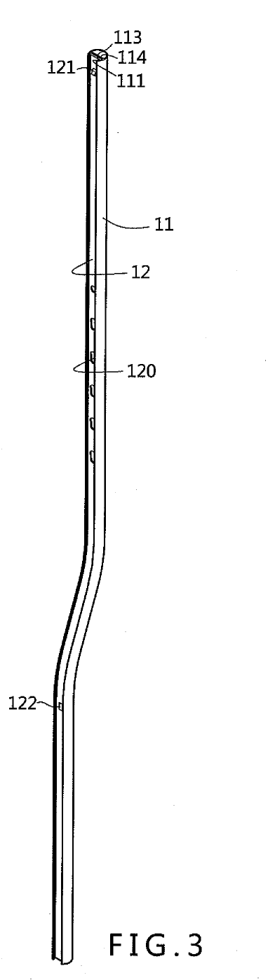

As shown in FIG. 2, the body 1 comprises two opposing shafts 11, and the two shafts 11 are disposed in parallel with an upper distance therebetween being wider and a lower distance therebetween being narrower; one side of each shaft 11 is formed with a slit 111 for receiving a handgrip 3, and two fastening grooves 112 are oppositely disposed on two lateral walls within the slit 111 of each shaft 11, respectively; a wall portion 12 made of a fortified material is disposed between the two fastening grooves 112, so that a sliding groove 113 that is wider interiorly and narrower exteriorly is formed between the wall portion 12 and the opening of the slit 111; a connecting portion 114 is disposed adjacent to the wall portion 12 (facing the sliding groove 113) in each shaft 11. A protrusion 121 and an indentation 122 are disposed between the shoulder support 2 and the middle tube 4 on the wall portion 12; in other words, the protrusion 121 and the indentation 122 are disposed between the upper end of the wall portion 12 and the location of the upper end of the middle tube 4; a plurality of positioning holes 120 are disposed on the wall portion 12 within a range in which the position of the handgrip 3 may be adjusted; each of the positioning holes 120 has a wider upper opening and a narrower lower opening, so that the wall portions 12 may be secured within the shafts 11 after being fitted into and bent into a predetermined shape along with the shafts 11 (as shown in FIG. 3).

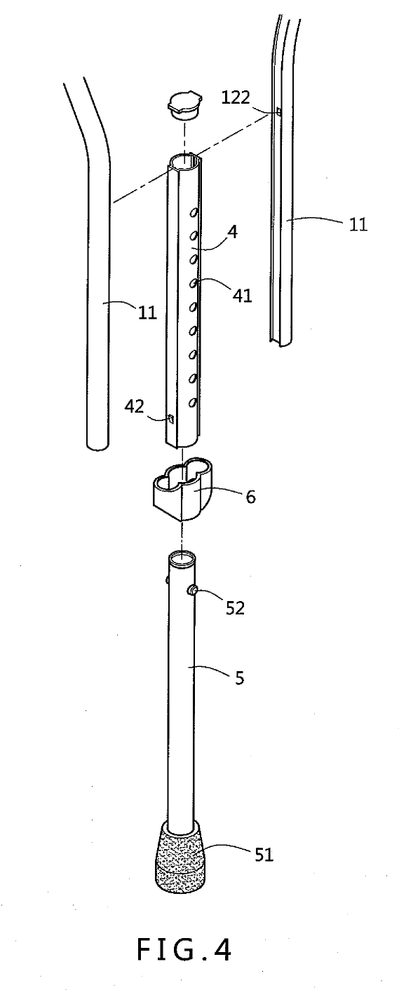

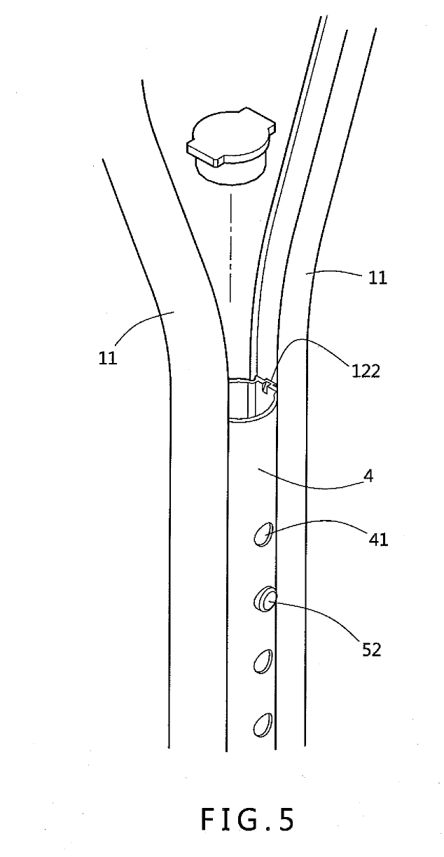

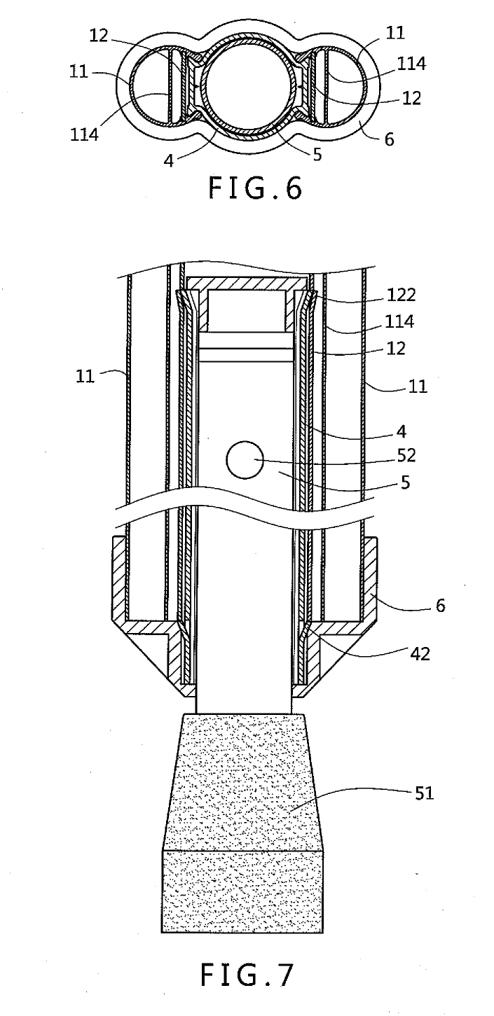

Referring to FIGS. 4, 5, 6, and 7; a lower tube 5 included with a padding 51 at a lower end thereof is fitted through a middle tube 4, and a plurality of positioning holes 41 are laterally formed on the middle tube 4 for a spring 52 of the lower tube 5 to fit into, while the two lateral sides at the lower end of the middle tube 4 are formed with protrusions with positioning portions 42; so that when the middle tube 4 is fitted between the two shafts 11, the two lateral sides at the upper end thereof may be embedded into the indentations 122 disposed on the wall portions 12 of the two shafts 11, whereas the positioning portions 42 on the two lateral sides at the lower end of the middle tube 4 fit with and hold the shafts 11, so as to allow the middle tube 4 and the two shafts 11 to become fastened together, and a joiner 6 is fitted at the lower end of the middle tube 4 and the two shafts 11.

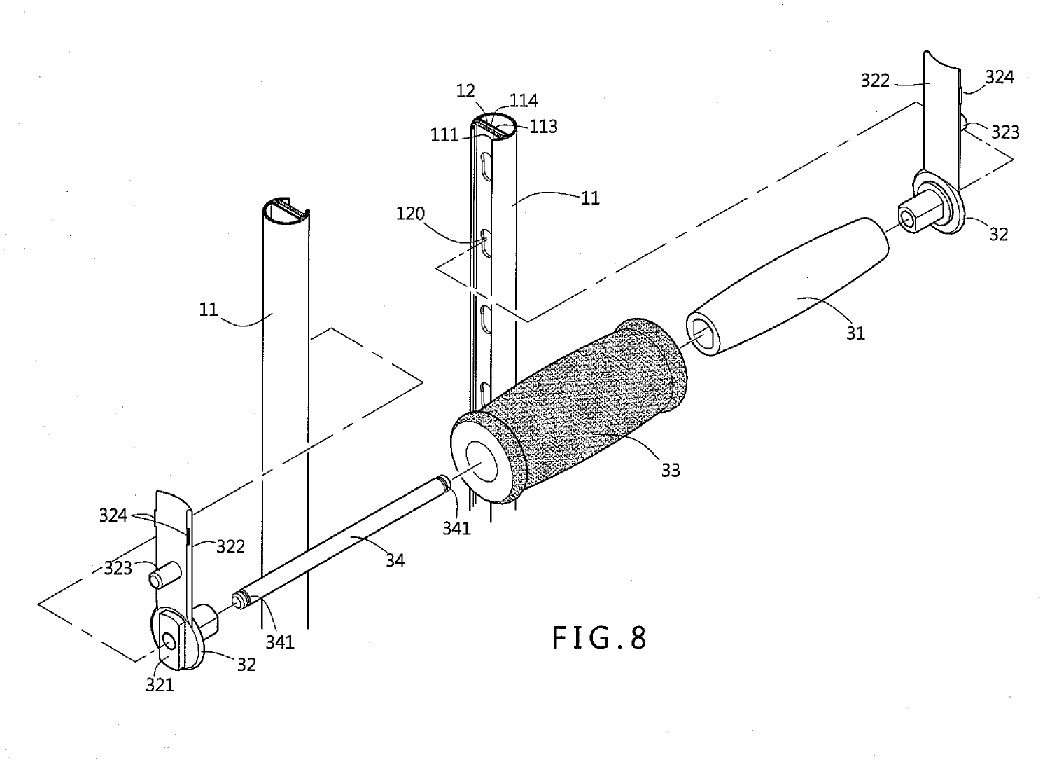

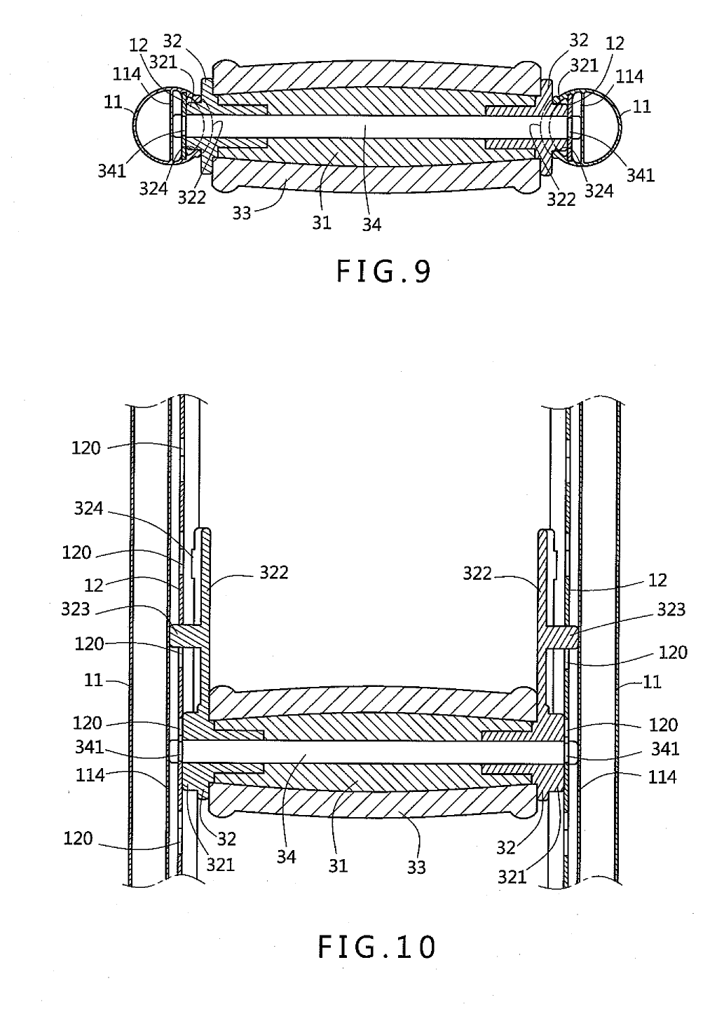

Referring to FIGS. 8, 9, and 10; the handgrip 3 fitted between the shafts 11 includes a bar 31 enclosed with foam 33 and fitted with plugs 32 at two ends thereof, a pivot 34 disposed with grooves 341 at the two ends thereof is fitted through the bar 31; the two ends of the pivot 34 may protrude out of the plugs 32 at both sides and become fastened with the narrower lower opening of each positioning hole 120 by the means of the grooves 341 thereof. The external side of each plug 32 is formed with a sliding portion 321 that may slide in each sliding groove 113, and an elastic extended portion 322 with an arc-shaped external side extends up from the plug 32; the extended portion 322 includes a protrusion 323 that may fit into the wider upper opening of a corresponding positioning hole 120; a clip-on portion 324 also protrudes onto an upper end of each extended portion 322, so that the clip-on portion 324 may fit into the slit 111 of the shafts 11, thereby securing the extended portion 322 onto the shafts 11.

It should be noted that the wall portions 12 fitted into the shafts 11 of the body 1 are formed with positioning holes 120, protrusions 121, and indentation 122 before being fitted into the shafts 11 and bent into a predetermined shape along with the shafts 11, so as to secure the wall portions 12 and the shafts 11 together. Subsequently, other components such as the shoulder support 2, the handgrip 3, the middle tube 4, the lower tube 5, and the joiner 6 are assembled to complete the axillary crutch invention. As a result, the axillary crutch may be conveniently and easily assembled, and the structural strength of the shafts 11 is reinforced because the shafts 11 are free from the damage resulting from processing or assemblage, and also because the shafts are embedded with the wall portions 12, and thus the body 1 is allowed to hold heavier loads. Moreover, the cost for making the shafts 11 can be reduced significantly because the expensive aluminum alloy the shafts 11 are made of may be largely replaced with wall portions 12, which are made of fortified and inexpensive steel alloy. Therefore, the cost for making the body 1 may be lowered greatly while still maintaining the strength of the body 1 at an acceptable level.

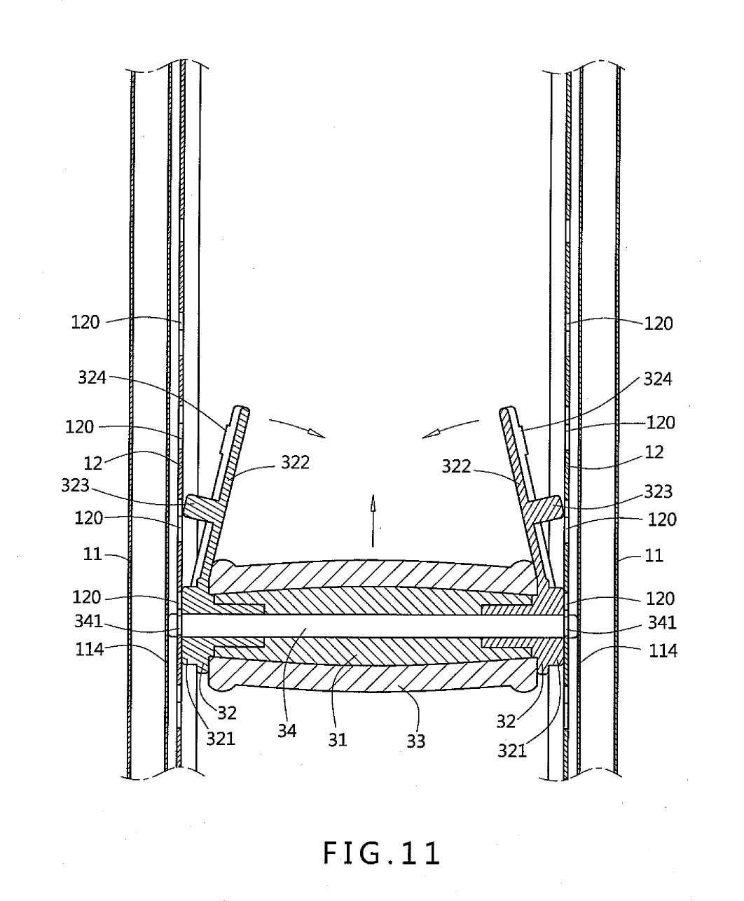

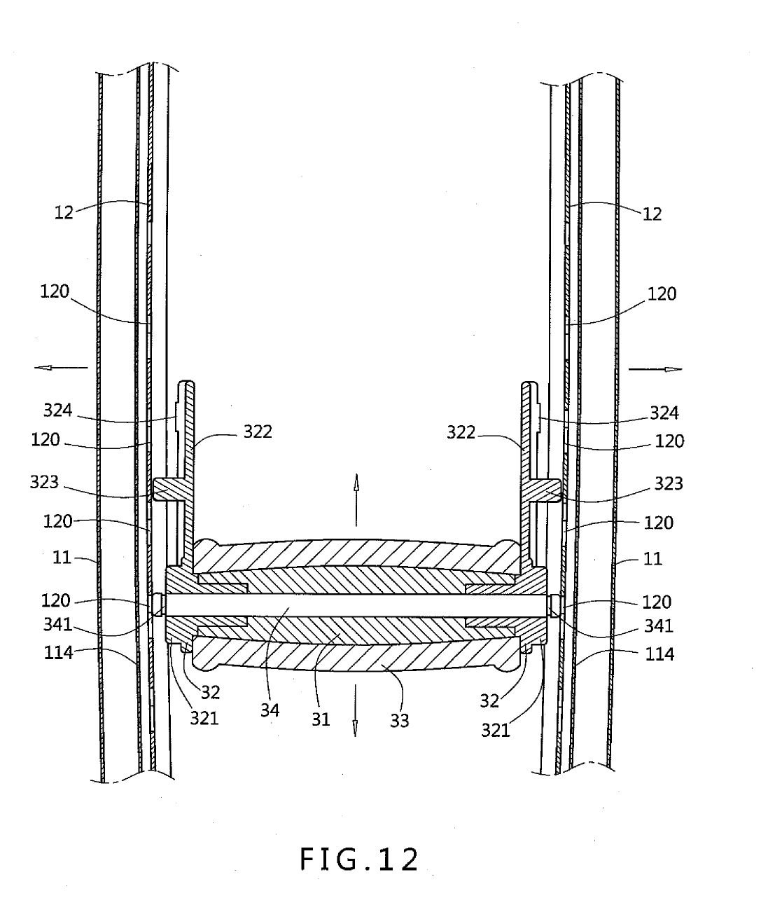

Referring to FIG. 11, when it is necessary to adjust the position of the handgrip 3, a free end of the extended portion 322 of the plug 32 is first pulled inwards, so that the protrusion 323 is removed from the positioning hole 120, and then the whole handgrip 3 is pulled upwards to allow the pivot 34 to move from the narrower opening to the wider opening of the positioning hole 120. Subsequently, the two shafts 11 are pulled apart slightly (as shown in FIG. 12) to allow the two ends of the pivot 34 to completely move out of the positioning hole 120; after the handgrip 3 has been moved upwards or downwards to the desired position, the two shafts 11 are pushed back to the original position in which the shafts 11 are parallel to each other, and then the two ends of the pivot 34 are pushed into the corresponding positioning hole 120 before pushing the handgrip 3 downwards to allow the grooves 341 at both ends of the pivot 34 to fit into the narrower lower opening of the positioning hole 120, while the protrusion 323 on the extended portion 322 of the plug 32 is also fitted into the wider upper opening of the positioning hole 120. As a result, the handgrip 3 is secured and prevented from moving downwards or upwards, and the grooves 341 at both ends of the pivot 34 can also hold the two shafts 11 in position; thereby preventing the two shafts 11 from bending or moving outwards and reinforcing the security of the axillary crutch.

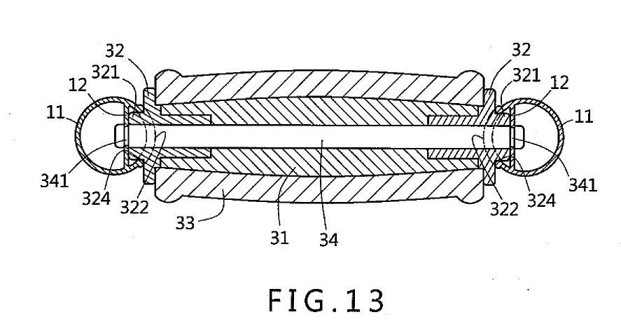

Furthermore, the aforesaid handgrip 3 may also be applied to a shaft 11 as indicated in FIG. 13, in which a wall portion 12 may be integrally formed in a shaft 11 with sliding grooves 113, while said wall portion 12 may also be formed with positioning holes 120, protrusions 121, and indentations 122. Consequently, the aforesaid handgrip 3 may also be disposed between the two shafts 1 1, as well as adjusted and positioned in the same manner described above.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A reinforced axillary crutch with adjustable handgrip, comprising:
a body including two opposite shafts that may be bent according to actual needs;
a shoulder support being disposed on top of the body;
a handgrip being disposed in the middle of the body for users to hold onto;
a lower tube being disposed at a lower end of the body that may be slid to adjust for positioning;
wherein for the two opposite shafts used to form the body, one side of each shaft is formed with a slit for receiving the handgrip, and the two sides face each other; two fastening grooves are disposed opposite each other on two lateral walls within the slit of each shaft, respectively, and a wall portion is disposed between the two fastening grooves; a sliding groove that is wider interiorly and narrower exteriorly is formed between the wall portion and the opening of the slit in each shaft; a connecting portion is disposed adjacent to the wall portion (facing the sliding groove) in each shaft, so that the wall portions may be secured within the shafts after being fitted into and bent into a predetermined shape along with the shafts.

2. The axillary crutch of claim 1, wherein the wall portion within a range for adjusting the handgrip is formed with a plurality of positioning holes for positioning the handgrip; each of the positioning holes has a wider upper opening and a narrower lower opening.

3. A reinforced axillary crutch with adjustable handgrip, comprising:
a body including two opposite shafts that may be bent according to actual needs;
a shoulder support being disposed on top of the body;
a handgrip being disposed in the middle of the body for users to hold onto;
a lower tube being disposed at a lower end of the body that may be slid to adjust for positioning;
wherein for the two opposite shafts used to form the body, one side of each shaft is formed with a slit for receiving the handgrip, and the two sides face each other; a wall portion is formed at the opening of the slit within each shaft, so that a sliding groove that is wider interiorly and narrower exteriorly is formed between the wall portion and the opening of the slit in each shaft; the wall portion within a range for adjusting the handgrip is formed with a plurality of positioning holes, and each positioning hole has a wider upper opening and a narrower lower opening;
a pivot is fitted through the handgrip; the pivot has two respective ends disposed with grooves for fastening with or separating from the narrower lower opening of each positioning hole, and the two ends correspond to the sliding grooves of each of the shafts, respectively; an extended portion having a protrusion that may fit into the wider upper opening of the corresponding positioning hole is extended up from the two ends of the handgrip.

4. A reinforced axillary crutch with adjustable handgrip, comprising:
a body including two opposite shafts that may be bent according to actual needs;
a shoulder support being disposed on top of the body;
a handgrip being disposed in the middle of the body for users to hold onto;
a lower tube being disposed at a lower end of the body that may be slid to adjust for positioning;
wherein for the two opposite shafts used to form the body, one side of each shaft is formed with a slit for receiving the handgrip, and the two sides face each other; two fastening grooves are disposed opposite each other on two lateral walls within the slit of each shaft, respectively, and a wall portion is disposed between the two fastening grooves; a sliding groove that is wider interiorly and narrower exteriorly is formed between the wall portion and the opening of the slit in each shaft; the wall portion within a range for adjusting the handgrip is formed with a plurality of positioning holes for positioning the handgrip; each of the positioning holes has a wider upper opening and a narrower lower opening; a connecting wall is disposed adjacent to the wall portion (facing the sliding groove) in each shaft, so that the wall portions may be secured within the shafts after being fitted into and bent into a predetermined shape along with the shafts;
a pivot is fitted through the handgrip; the pivot has two respective ends disposed with grooves for fastening with or separating from the narrower lower opening of each positioning hole, and the two ends correspond to the sliding grooves of each of the shafts, respectively; an extended portion having a protrusion that may fit into the wider upper opening of the corresponding positioning hole is extended up from the two ends of the handgrip.
